(19) United States
(12) Patent Application Publication
(10) Pub. No.: US 2012/0309367 A1
(43) Pub. Date: Dec. 6, 2012

(54) COMMUNICATION TERMINAL, COMMUNICATION METHOD, AND COMPUTER READABLE STORAGE MEDIUM HAVING COMMUNICATION PROGRAM STORED THEREIN

(76) Inventors: Fumihiko Takagi, Osaka-shi (JP); Masahide Takasugi, Osaka-shi (JP)

(21) Appl. No.: 13/578,984

(22) PCT Filed: Jan. 26, 2011
(86) PCT No.: PCT/JP2011/051438

§ 371 Date: Aug. 14, 2012

(30) Foreign Application Priority Data
Feb. 16, 2010 (JP) 2010-031204

(51) Int. Cl. H04W 4/16

(52) U.S. Cl. 455/414.1

(57) ABSTRACT

A communication terminal includes a first communication device, a second communication device, a speaker, a microphone, and a processor. The processor performs audio communication with another communication terminal via the first communication device, the speaker and the microphone and during the audio communication with the other communication terminal the processor receives an instruction issued to start data communication and while performing the audio communication the processor also performs the data communication in response to the instruction with the other communication terminal via the second communication device.

### TECHNICAL FIELD

The present invention relates to a communication terminal, a communication method, and a communication program for communication with another communication terminal, and particularly to a communication terminal, a communication method, and a computer readable storage medium having a communication program stored therein, that allow audio communication and data communication with another communication terminal.

### BACKGROUND ART

Conventionally, a communication terminal used for audio communication with another communication terminal has been known. For example, a mobile phone allows audio communication with another mobile phone through a career network. Furthermore, an Internet Protocol (IP) telephone utilizing a personal computer or the like is also known.

On the other hand, data communication by two or more communication terminals connectable to the Internet is also known. In recent years, a Peer to Peer (P2P) system or the like is utilized as a direct data communication system.

Furthermore, Japanese Patent Laying-Open 2000-261857 (PTL 1) discloses a mobile phone device. Japanese Patent Laying-Open 2000-261857 (PTL 1) describes that the mobile phone device includes two communication units, i.e., a CDMA communication unit which can communicate with a CDMA communication network, and a PHS communication unit which can communicate with a PHS communication network. The device controls the CDMA communication unit to communicate a speech received through a microphone to be transmitted, a speech received and output through a receiver, and the like as audio data with the CDMA communication network. The device controls the PHS communication unit to communicate a data terminal's data as non-audio data with the PHS communication network. The device allows the CDMA communication unit's audio data communication process and the PHS communication unit's non-audio data communication process to be done without interfering with each other, and thus allows a user to talk via the telephone and also communicate data at a high and stable communication rate.

### CITATION LIST

### Patent Literature

PTL 1: Japanese Patent Laying-Open No. 2000-261857

### SUMMARY OF INVENTION

### Technical Problem

However, it is still not studied what trigger or what process procedure is preferably used to activate both controlling audio communication and controlling data communication. In the future, there will be a demand for a user-friendly communication terminal capable of audio communication and data communication in parallel.

The present invention has been made to address such a problem, and its purpose is to provide a communication terminal, a communication method, and a computer readable storage medium having a communication program stored therein that are user-friendly and capable of audio communication and data communication in parallel.

### Solution to Problem

The present invention in one aspect provides a communication terminal for communicating with another communication terminal. The communication terminal includes: a first communication device; a second communication device; a speaker; a microphone; and a processor. The processor performs audio communication with the other communication terminal via the first communication device, the speaker and the microphone, receives during the audio communication with the other communication terminal an instruction issued to start data communication, and, while performing the audio communication, also performs the data communication in response to the instruction with the other communication terminal via the second communication device.

Preferably the communication terminal further includes a touch panel. During the data communication with the other communication terminal the processor receives a first handwritten image input via the touch panel and transmits the first handwritten image via the second communication device to the other communication terminal, and during the data communication with the other communication terminal the processor receives a second handwritten image from the other communication terminal via the second communication device and causes the touch panel to display the second handwritten image.

Preferably during the audio communication with the other communication terminal the processor causes the touch panel to display a software button operated to receive an instruction issued to start the data communication.

Preferably the communication terminal further includes a hardware button. During the audio communication with the other communication terminal the processor receives via the hardware button an instruction issued to start the data communication.

Preferably the processor shifts the communication terminal to a handsfree mode when the communication terminal starts the data communication.

The present invention in another aspect provides a communication method performed in a communication terminal including first and second communication devices, a speaker, a microphone, and a processor. The method includes the steps of: the processor performing audio communication with another communication terminal via the first communication device, the speaker and the microphone; during the audio communication with the other communication terminal, the processor receiving an instruction issued to start data communication; and while performing the audio communication, also performing the data communication in response to the instruction with the other communication terminal via the second communication device.

The present invention in still another aspect provides a computer readable storage medium having a communication program stored therein for causing a communication terminal to perform communication, the communication terminal including first and second communication devices, a speaker, a microphone, and a processor. The communication program causes the processor to perform the steps of: performing audio communication with another communication terminal via the first communication device, the speaker and the microphone; during the audio communication with the other communication terminal, receiving an instruction issued to start data communication; and while performing the audio communication, also performing the data communication in response to the instruction with the other communication terminal via the second communication device.

### Advantageous Effects of Invention

Thus the present invention provides a communication terminal, a communication method, and a computer readable storage medium having a communication program stored therein that are user-friendly and capable of audio communication and data communication in parallel.

### BRIEF DESCRIPTION OF DRAWINGS

FIG. 1 is a schematic diagram generally showing a configuration of a network system according to the present embodiment.

FIG. 2 is a sequence diagram outlining an operation in the network system.

FIG. 3 represents how data flows in the network system.

FIG. 4 represents a touch panel 104 during audio communication.

FIG. 5 shows an appearance of a mobile phone.

FIG. 6 is a block diagram showing a hardware configuration of the mobile phone.

FIG. 7 represents address book data, data of a terminal of interest, the IP address data of a partner of a communication, and the IP address data of the terminal of interest.

FIG. 8 is a block diagram showing a hardware configuration of a matching server.

FIG. 9 is a first image showing a data structure of a room management table, and a second image showing a data structure of a room management table.

FIG. 10 is a block diagram showing a functional configuration of the network system.

FIG. 11 represents one example of a message (or command) transmitted and received between the matching server and a first mobile phone and a second mobile phone.

FIG. 12 is a flow chart of a procedure of a communication process in the mobile phone.

FIG. 13 is a flow chart of a procedure of an outgoing call process in the mobile phone.

FIG. 14 is a flow chart of a procedure of an outgoing TEL call process in the mobile phone.

FIG. 15 is a flow chart of a procedure of a P2P communication process in the mobile phone.

FIG. 16 is a flow chart of a procedure of an incoming call process in the mobile phone.

FIG. 17 is a flow chart of a procedure of a response process in the matching server.

### DESCRIPTION OF EMBODIMENTS

Hereinafter reference will be made to the drawings to describe the present invention in an embodiment. In the following description, identical components are denoted by identical reference characters. Their names and functions are also identical. Accordingly, they will not be described repeatedly in detail.

Furthermore, hereinafter, a mobile phone 100 will be referred to as a representative example of a “communication terminal”. However, the communication terminal may be a personal computer, a car navigation device (a satellite navigation system), a personal navigation device (PND), personal data assistance (PDA) or other similar information communication equipment.

<General Configuration of Network System 1>

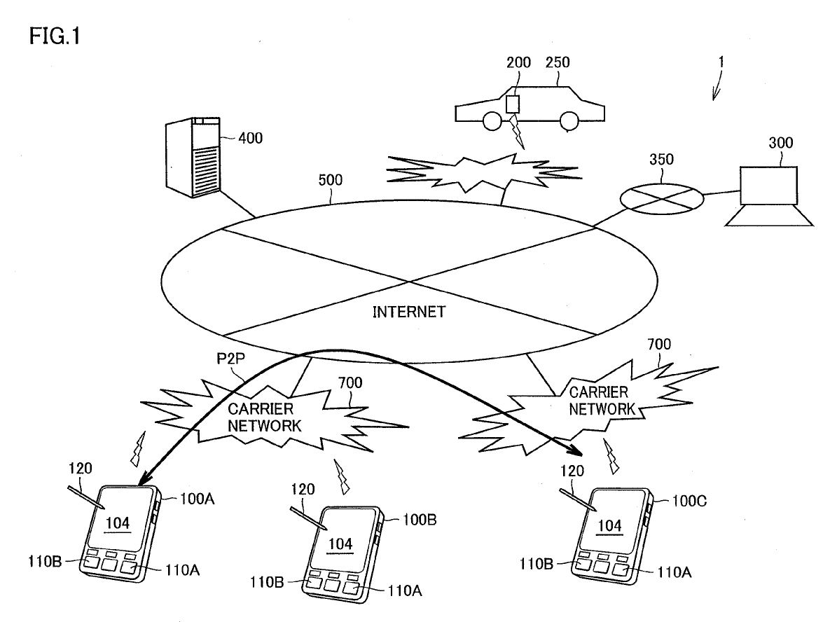

Initially, a network system 1 generally has a configuration, as will be described hereinafter. FIG. 1 is a schematic diagram showing a general configuration of network system 1 according to the present embodiment. With reference to FIG. 1, network system 1 includes mobile phones 100A, 100B and 100C, a matching server 400, Internet (a first network) 500, and a carrier network (a second network) 700. Furthermore, network system 1 according to the present embodiment includes a car navigation device 200 mounted in a vehicle 250, and a personal computer (PC) 300.

Note that, to facilitate description, hereinafter, network system 1 according to the present embodiment includes a first mobile phone 100A, a second mobile phone 100B, and a third mobile phone 100C. Furthermore, in describing a configuration, a function or the like common to mobile phones 100A, 100B and 100C, the mobile phones will also collectively be referred to as “mobile phone 100”. Furthermore, in describing a configuration, a function or the like common to mobile phones 100A, 100B and 100C, car navigation device 200, and personal computer 300, they will also collectively be referred to as a “communication terminal”.

Mobile phone 100 is configured to be connectable to carrier network 700. Car navigation device 200 is configured to be connectable to Internet 500. Personal computer 300 is configured to be connectable through a local area network (LAN) 350, a wide area network (WAN) or the like to Internet 500. Matching server 400 is configured to be connectable to Internet 500.

More specifically, first mobile phone 100A, second mobile phone 100B, and third mobile phone 100C are capable of mutual audio communication via the carrier network. More specifically, first mobile phone 100A, second mobile phone 100B, third mobile phone 100C, car navigation device 200, and personal computer 300 are capable of mutual audio communication via carrier network 700, Internet 500 and/or the like.

More specifically, mobile phone 100, car navigation device 200, and personal computer 300 are assigned telephone numbers for identifying their own terminals. In other words, mobile phone 100, car navigation device 200, and personal computer 300 can each store the telephone numbers of the other communication terminals in its internal storage medium and perform audio communication, as based on those telephone numbers, with the other communication terminals via carrier network 700, Internet 500 and/or the like.

Furthermore, first mobile phone 100A, second mobile phone 100B, third mobile phone 100C, car navigation device 200, and personal computer 300 are capable of mutually transmitting and receiving data via carrier network 700, Internet 500 and/or the like.

More specifically, mobile phone 100, car navigation device 200, and personal computer 300 are assigned identification information such as a telephone number, a mail address, an Internet Protocol (IP) address or the like for identifying their own terminals. In other words, mobile phone 100, car navigation device 200, and personal computer 300 can each store identification information of the other communication terminals in its internal storage medium and communicate data, as based on that identification information, with the other communication terminals via carrier network 700, Internet 500 and/or the like.

Note that mobile phone 100, car navigation device 200, and personal computer 300 may use IP addresses that are temporarily assigned in accessing Internet 500 to each communicate data with the other communication terminals. When the communication terminal according to the present embodiment accesses Internet 500, the communication terminal is assigned an IP address by matching server 400 or another server device (not shown) for the sake of illustration. The IP address is assigned in a process known in detail, and accordingly, how the IP address is assigned will not be described in detail.

Furthermore, mobile phone 100, car navigation device 200, and personal computer 300 according to the present embodiment can use their assigned IP addresses to directly, mutually communicate data on a network. That is, network system 1 according to the present embodiment includes mobile phone 100, car navigation device 200, and personal computer 300 capable of configuring a so-called pear-to-pear (P2P) type network.

<Outlining How Network System 1 Operates>

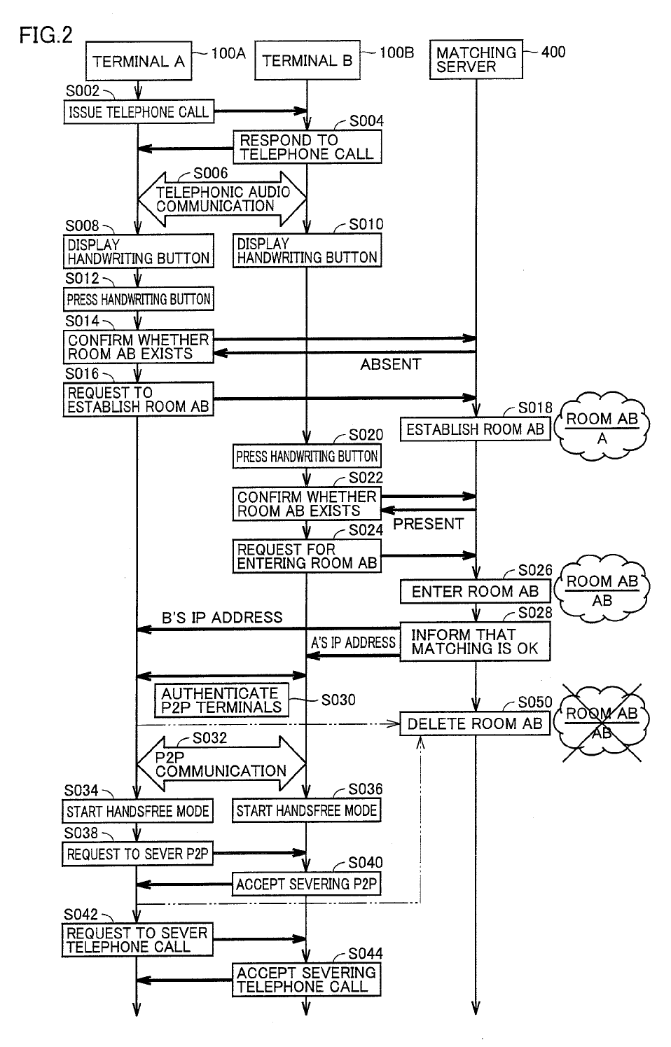

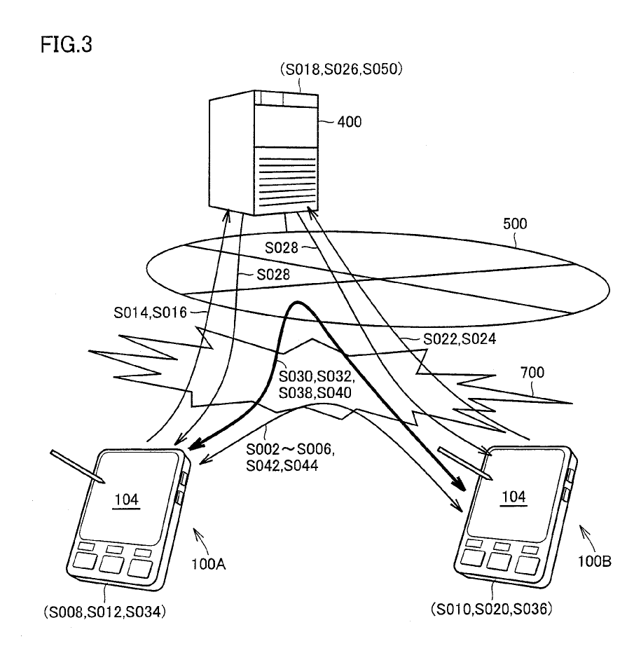

Network system 1 according to the present embodiment generally operates, as will be described hereinafter. FIG. 2 is a sequence diagram outlining how network system 1 operates. FIG. 3 represents how data flows in network system 1.

With reference to FIG. 2 and FIG. 3, the communication terminal according to the present embodiment starts audio communication in response to an instruction (a first instruction) issued to start audio communication performed from a user. For example, the communication terminal starts audio communication based on a partner's telephone number stored in a memory. Thereafter, during the audio communication, the communication terminal receives an instruction issued to start P2P communication, and accordingly starts the P2P communication with the partner of the audio communication.

Note that in order to perform P2P type data communication, it is necessary to exchange (or obtain) mutual IP addresses. In the present embodiment, each communication terminal obtains mutual IP addresses via matching server 400 and thereafter performs P2P type data communication based on the IP addresses.

More specifically in the present embodiment will be described an example where in starting P2P communication, communication terminals each transmit and receive an IP address, a message, an attached file and/or the like via a chat room (hereinafter also simply be referred to as a “room”) created in matching server 400. In particular, hereinafter will be described an example where first mobile phone 100A creates a new chat room and second mobile phone 100B during audio communication with first mobile phone 100A enters that chat room.

With reference to FIG. 2 and FIG. 3, first mobile phone 100A (in FIG. 2, a terminal A) initially receives from a user who is selected as a partner for audio communication. In response, first mobile phone 100A makes an outgoing call (a telephone call) to second mobile phone 100B selected (step S002). In response to the outgoing call received from first mobile phone 100A, second mobile phone 100B outputs a ringer tone through a speaker. Second mobile phone 100B responds to the outgoing call (or responds telephonically), as operated by the user (step S004).

First mobile phone 100A and second mobile phone 100B control audio communication (step S006). Thus the user of first mobile phone 100A and the user of second mobile phone 100B can enjoy audio communication.

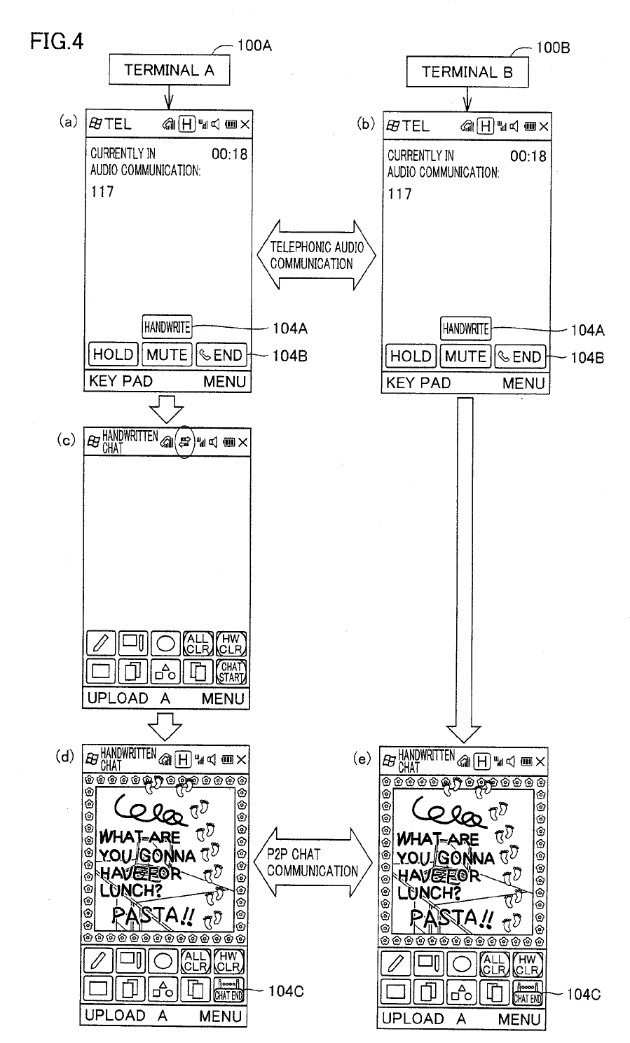

Herein, a display screen (or touch panel 104) of the communication terminal during audio communication will be described. FIG. 4 represents touch panel 104 during audio communication.

As shown in FIG. 4(a), in the present embodiment, once audio communication has started, first mobile phone 100A displays a handwriting button 104A (a P2P communication starting button, or a chat communication starting button) on touch panel 104 (step S008). Handwriting button 104A is a software button used to start P2P communication with a partner of audio communication in parallel with that audio communication. When the user touches handwriting button 104A (step S012), first mobile phone 100A starts P2P communication.

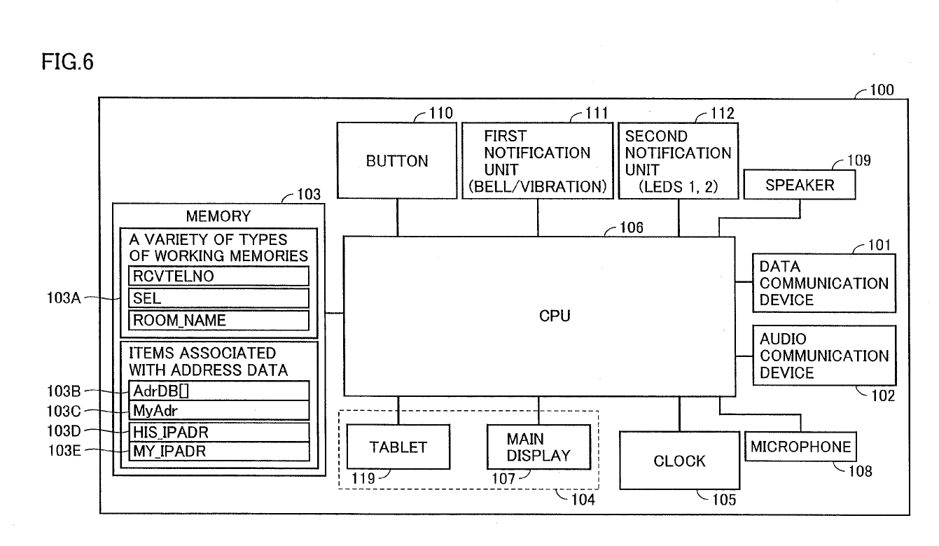

Note, however, that first mobile phone 100A may cause any of hardware buttons (button 110 in FIG. 6) to serve as a handwriting button during audio communication (step S008). The button may be assigned a different function when audio communication is not performed. In other words, when the user presses the hardware button (step S012), first mobile phone 100A starts a P2P communication connection process. Similarly, as shown in FIG. 4(b), in the present embodiment, second mobile phone 100B displays handwriting button 104A (a P2P communication starting button or a chat communication starting button) on touch panel 104 during audio communication (step S010). Handwriting button 104A is a software button used to start P2P communication with a partner of audio communication in parallel with that audio communication. In other words, when the user touches handwriting button 104A (step S020), second mobile phone 100B starts P2P communication.

Note that second mobile phone 100B may also cause any of hardware buttons to serve as a handwriting button during audio communication (step S010). The button may be assigned a different function when audio communication is not performed. In other words, when the user presses the hardware button (step S020), second mobile phone 100B starts the P2P communication connection process.

Thus, when handwriting button 104A is pressed (step S012), first mobile phone 100A activates an application for P2P communication.

Specifically, as shown in FIG. 4(c), first mobile phone 100A displays a window on touch panel 104 for P2P communication. First mobile phone 100A creates a room name from the telephone number of first mobile phone 100A and that of second mobile phone 100B, for example. First mobile phone 100A inquires of matching server 400 whether a room AB exists in matching server 400, based on that room name (step S014).

If not, first mobile phone 100A transmits a request to matching server 400 to create (or establish) a new room (step S016). More specifically, first mobile phone 100A transmits to matching server 400 a request including the room name to create a room. Matching server 400 receives the request including the room name, and establishes a room corresponding to the room name (step S018).

More specifically, first mobile phone 100A in establishing a room may obtain its own IP address from matching server 400 or may obtain an IP address previously from another server or the like for example when it is connected to internet 500. Matching server 400 in creating the room associates the room name with identification information (the IP address or the like) of first mobile phone 100A and thus stores them.

The user of second mobile phone 100B is requested by the user of first mobile phone 100A for example through audio communication to press handwriting button 104A. The user of second mobile phone 100B presses handwriting button 104A (step S020), and second mobile phone 100B in response activates the application for P2P communication.

Specifically, as shown in FIG. 4(c), second mobile phone 100B also displays a window on touch panel 104 for P2P communication. Second mobile phone 100B creates a room name, based on the telephone number of first mobile phone 100A and that of its own, in accordance with a predetermined role.

Thus in the present embodiment network system 1 allows first mobile phone 100A and second mobile phone 100B to both employ identical information to create a room name. In other words, network system 1 is configured so that the first and second mobile phones create identical room names. It should be noted, however, that network system 1 is only required to be configured such that first and second mobile phones can create identical room names, and network system 1 may not be configured to create a room name based on the first and second mobile phones' telephone numbers.

Second mobile phone 100B having created a room name inquires of matching server 400 whether a room corresponding to that room name exists in matching server 400 (step S022). If so, second mobile phone 100B issues a request to matching server 400 for entering room AB (a request for participation) (step S024). Matching server 400 receives the request and registers the identification information of second mobile phone 100B in association with the room name of room AB (step S026).

More specifically, second mobile phone 100B in entering the room may obtain its own IP address from matching server 400 or may obtain an IP address previously from another server or the like for example when it is connected to internet 500. When second mobile phone 100B enters the room, matching server 400 associates the room name with the identification information (the IP address or the like) of second mobile phone 100B and thus stores them.

Then, matching server 400 notifies first mobile phone 100A and second mobile phone 100E that a matching process has successfully been done (step S028). In other words, matching server 400 transmits to first mobile phone 100A and second mobile phone 100B their mutual identification information.

First mobile phone 100A and second mobile phone 100B use their mutual identification information to authenticate each other (step S030). Once the authentication has been completed, first mobile phone 100A and second mobile phone 100B start P2P communication (or handwritten chat communication) as shown in FIG. 4(d) and FIG. 4(e) (step S032).

In the present embodiment, when handwriting button 104A is pressed, first mobile phone 100A and second mobile phone 100B shift to a handsfree mode or a speaker phone mode. More specifically, when handwriting button 104A is pressed, first mobile phone 100A and second mobile phone 100B increase the speaker's volume (or its output's amplification factor) or the microphone's sensitivity (or its input's amplification factor) or the like. In other words, first mobile phone 100A and second mobile phone 100B shift to a mode that allows speech to be caught from the speaker or input through the microphone while the users have a handwritten chat, i.e., while the users handwrite inputs with stylus pen 120 via touch panel 104.

When first mobile phone 100A receives an instruction from the user to end the P2P communication, it transmits a message to second mobile phone 100B to end the P2P communication (step S038). For example, when the user presses an end P2P button 104C, first mobile phone 100A clear the handsfree mode and transmits the above message to second mobile phone 100B.

Second mobile phone 100B answers the message and clears the handsfree mode (step S040). Thus first mobile phone 100A and second mobile phone 100B end the P2P communication. In other words, first mobile phone 100A and second mobile phone 100B continue only the audio communication.

When first mobile phone 100A receives an instruction from the user to end the audio communication, it transmits a request to second mobile phone 100B to disconnect the telephone (step S042). Second mobile phone 100B responds to the request (step S044). Note, however, that when first mobile phone 100A and second mobile phone 100B receive an instruction to end audio communication during P2P communication, they may end only the audio communication while continuing the P2P communication.

Network system 1 according to the present embodiment has a configuration and an effect, as summarized as follows:

In order to perform audio communication and data communication, it is necessary that each communication terminal obtain identification information on a partner's communication terminal for the audio communication (e.g., a telephone number or the like), and identification information on the partner's communication terminal for the data communication (e.g., an IP address or the like). Network system 1 according to the present embodiment allows a plurality of communication terminals during audio communication to each receive an instruction issued to receive data communication to the audio communication. Accordingly, the communication terminals can each determine a partner of the audio communication as a partner of the data communication. Then, the communication terminals each obtain identification information on the partner of the audio communication for the data communication, based on the identification information on the partner of the audio communication for the audio communication, via matching server 400. As a result, simply by pressing handwriting button 104A, the communication terminals' respective users can perform handwritten data communication while performing audio communication.

Such a function as described above will be implemented in a configuration, as will be described hereinafter more specifically.

<Hardware Configuration of Mobile Phone 100>

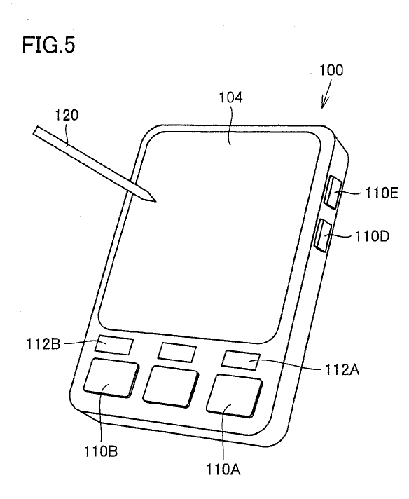

Mobile phone 100 according to the present embodiment serving as one example of a communication terminal has a hardware configuration, as will be described hereinafter. FIG. 5 generally shows an appearance of mobile phone 100 according to the present embodiment. FIG. 6 is a block diagram showing a hardware configuration of mobile phone 100 according to the present embodiment.

With reference to FIGS. 5 and 6, mobile phone 100 according to the present embodiment includes a data communication device 101 for communicating data with another communication terminal via Internet 500, an audio communication device 102 for performing audio communication with another communication terminal via a telephone line (e.g. carrier network 700), a memory 103 storing a program and a variety of types of databases, a central processing unit (CPU) 106, a display 107, a microphone 108 receiving external sound, a speaker 109 outputting sound, a button 110 receiving a variety of types of information input, a first notification unit 111 outputting audible notification indicating that externally communicated data, a call signal and/or the like have/has been received, and a second notification unit 112 displaying notification indicating that externally communicated data, a call signal and/or the like have/has been received.

Note that data communication device 101 and audio communication device 102 are configured for example of an antenna, a signal processing circuit and/or the like, and may be implemented by the same device. For example, personal computer 300 may perform handwritten chat communication while making an IP telephone call via a single communication interface.

More specifically, mobile phone 100 according to the present embodiment is provided with a pen tablet 119 on an upper (or front) side of display 107. This allows a user to use a stylus pen 120 or the like to handwrite and thus input graphical information or the like through pen tablet 119 to CPU 106. Display 107 displays an image, a text and/or the like based on data output by CPU 106. In other words, in the present embodiment, display 107 and pen tablet 119 configure touch panel 104.

Button 110 is a hardware button for receiving information from a user operating a key for input or the like. For example, button 110 includes a TEL button 110A for receiving a telephone call and making a telephone call, a P2P button 110B for receiving P2P communication and sending P2P communication, an address book button 110D used to access address book data, and an end button 110E for terminating a variety of types of processes. That is, when P2P participation request mail is received via audio communication device 102, button 110 selectably receives instructions input by a user to enter a chat room, display the mail's content(s), and the like.

First notification unit 111 outputs a ringer tone through speaker 109 or the like. Alternatively, first notification unit 111 has a vibration function. When an incoming call, P2P participation request mail and/or the like are/is received, first notification unit 111 outputs sound, vibrates mobile phone 100, and/or the like.

Second notification unit 112 includes a light emitting diode (LED) 112A for TEL, and an LED 112B for P2P. LED 112A for TEL flashes on/off when an incoming call arrives. LED 112B for P2P flashes on/off when P2P communication is received.

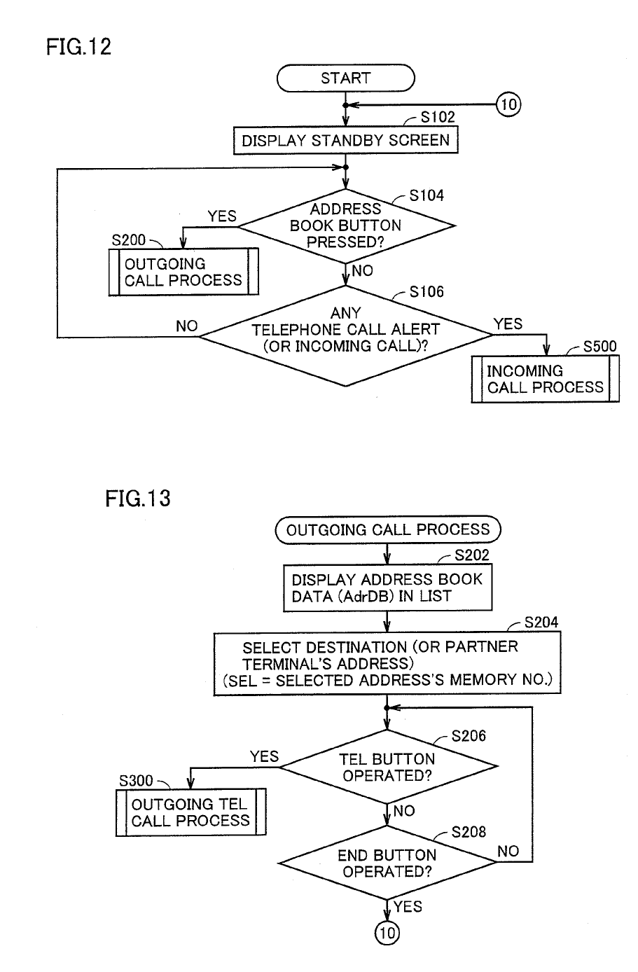

CPU 106 controls each unit of mobile phone 100. For example, CPU 106 receives a variety of types of instructions from a user via button 110, and communicates data with an external communication terminal via data communication device 101, audio communication device 102, a network and/or the like. CPU 106 performs the steps shown in FIG. 12 to FIG. 16, as based on a program externally downloaded or previously stored in memory 103, as will be described hereinafter.

Data communication device 101 receives data from CPU 106 to be communicated and transmits the data via an antenna (not shown). Data communication device 101 receives communicated data via an antenna and inputs the data to CPU 106.

Audio communication device 102 receives an audio signal from CPU 106 and transmits the audio signal via an antenna (not shown). Audio communication device 102 receives an audio signal via an antenna and inputs the audio signal to CPU 106.

Memory 103 is implemented as: random access memory (RAM) functioning as working memory; flash memory storing a control program, image data and/or the like; and/or the like. Memory 103 has a variety of work memory 103A, which includes an RCVTELNO area storing an originator's telephone number, an SEL area storing the memory number of an address selected, and a ROOMNAME area storing a room name created.

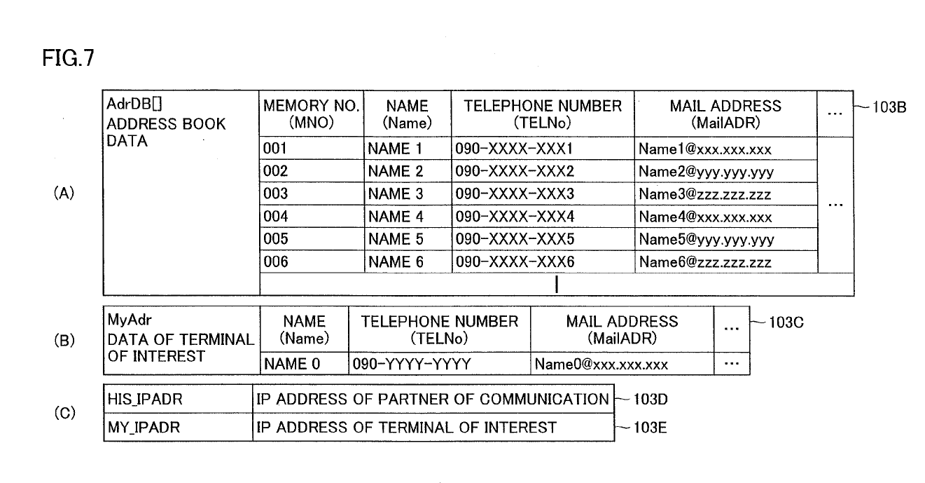

FIG. 7(A) represents address book data 103B stored in memory 103. FIG. 7(B) represents data 103C of a terminal of interest stored in memory 103. FIG. 7(C) represents IP address data 103D of a partner of a communication and IP address data 103E of the terminal of interest, stored in memory 103.

With reference to FIG. 7(A), address book data (AdrDB[ ]) 103B associates a memory number for each destination (or for each other communication terminal). Address book data 103B associates a name, a telephone number, a mail address, a nickname and the like with one another for each destination, and thus stores them. With reference to FIG. 7(B), memory 103 stores the name of the user of the terminal of interest, the telephone number of the terminal of interest, the mail address of the terminal of interest, a nickname, and the like as data (MyAdr) 103C for the terminal of interest.

With reference to FIG. 7(C), memory 103 stores IP address data (HIS_JPADR) 103D of a partner of a communication and IP address data (MY_JPADR)103E of the terminal of interest.

<Hardware Configuration of Matching Server 400>

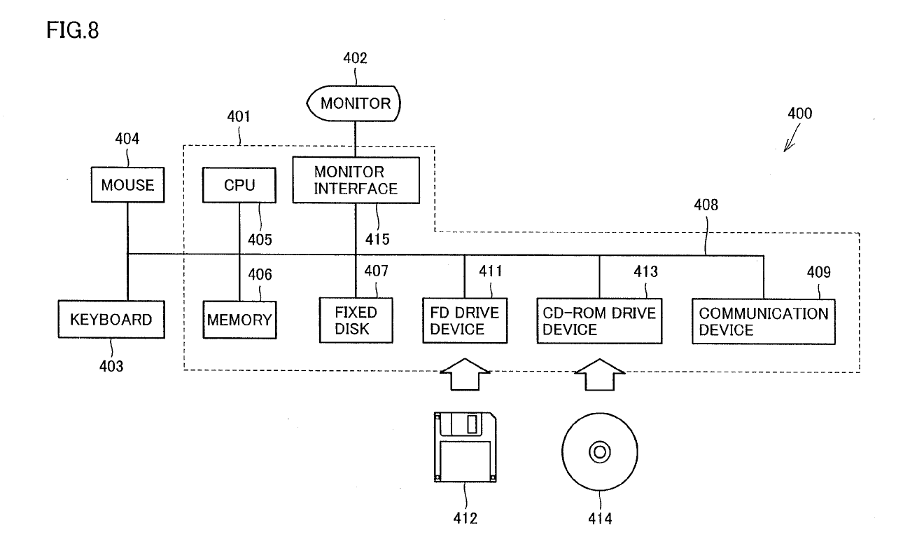

The present embodiment provides matching server 400 having a hardware configuration, as will be described hereinafter. FIG. 8 is a block diagram showing a hardware configuration of matching server 400 according to the present embodiment.

With reference to FIG. 8, matching server 400 according to the present embodiment includes a CPU 405, a memory 406, a fixed disk 407, and a communication device 409 interconnected by an internal bus 408.

Memory 406 stores a variety of types of information, and for example temporarily stores data required for execution of a program in CPU 405. Fixed disk 407 stores a program executed by CPU 105, a database, and the like. CPU 405, which controls each element of matching server 400, is a device performing a variety of types of operations.

Communication device 409 receives data output from CPU 405, converts the data to an electrical signal, and externally transmits the signal, and communication device 409 also converts an externally received electrical signal to data and inputs the data to CPU 405. More specifically, communication device 409 receives data from CPU 405 and transmits the data on Internet 500, carrier network 700, and/or the like to mobile phone 100, car navigation device 200, personal computer 300 and/or the like. Communication device 409 also receives data via Internet 500, carrier network 700 and/or the like from mobile phone 100, car navigation device 200, personal computer 300 and/or the like and inputs the data to CPU 405.

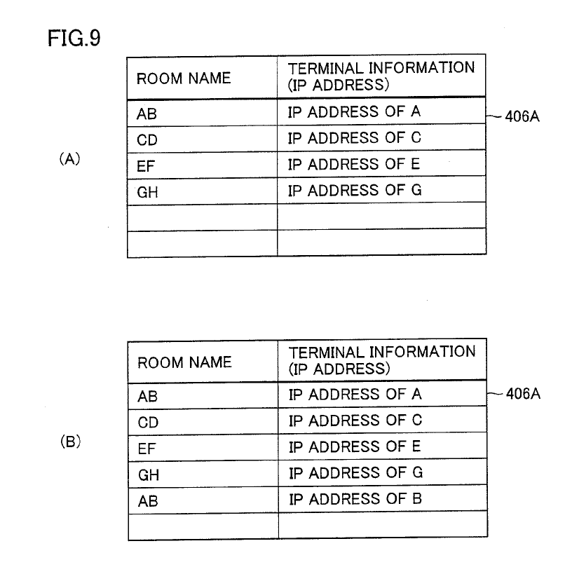

What data memory 406 or fixed disk 407 has stored therein will be described hereinafter. FIG. 9(A) is a first representation of a data structure of a room management table 406A stored in matching server 400 at memory 406 or fixed disk 407. FIG. 9(B) is a second representation of a data structure of room management table 406A stored in matching server 400 at memory 406 or fixed disk 407.

With reference to FIG. 9(A) and FIG. 9(B), room management table 406A associates a room name for each room with identification information of any communication terminal(s) currently in the room and thus stores them. For example, at a point in time, with reference to FIG. 9(A), chat rooms having room names AB, CD, EF and GH, respectively, are created in matching server 400.

In the present embodiment, room name AB is determined by a communication terminal A from the telephone number of communication terminal A and that of communication terminal B. Room name CD is determined by a communication terminal C from the telephone number of communication terminal C and that of communication terminal D. Room name EF is determined by a communication terminal E from the telephone number of communication terminal E and that of communication terminal F. Room name GH is determined by a communication terminal G from the telephone number of communication terminal G and that of communication terminal H.

In the chat room with room name AB is communication terminal A. Accordingly, room management table 406A associates the IP address of communication terminal A with room name AB and thus stores them. In the chat room with room name CD is communication terminal C. Accordingly, room management table 406A associates the IP address of communication terminal C with room name CD and thus stores them. In the chat room with room name EF is communication terminal E. Accordingly, room management table 406A associates the IP address of communication terminal E with room name EF and thus stores them. In the chat room with room name GH is communication terminal G. Accordingly, room management table 406A associates the IP address of communication terminal G with room name GH and thus stores them.

With reference to FIG. 9(B), when communication terminal B additionally enters the chat room having room name AB, room management table 406A associates the IP address of communication terminal B with room name AB and thus stores them.

For example, when matching server 400 receives a request from first mobile phone 100A to create a new chat room (as indicated in FIG. 2 at step S016), matching server 400 obtains a room name from the request, and then associates that room name with the IP address of first mobile phone 100A and thus stores them in room management table 406A. Then, when second mobile phone 100B requests matching server 400 to allow second mobile phone 100B to enter a chat room (as indicated in FIG. 2 at step S024), CPU 405 associates that room name with the IP address of second mobile phone 100B and thus stores them in room management table 406A.

Then, once a predetermined condition for that room has been satisfied, CPU 405 reads from room management table 406A the IP address of first mobile phone 100A, that of second mobile phone 100B and the like associated with that room name. CPU 405 transmits the IP address of first mobile phone 100A to each second communication terminal, and transmits the IP address of second mobile phone 100B to first mobile phone 100A.

Note that the predetermined condition corresponds for example to: that the number of IP addresses associated with a room name has reached a preset number; that a preset time has elapsed since a room was created; and the like.

<Functional Configuration of Network System 1>

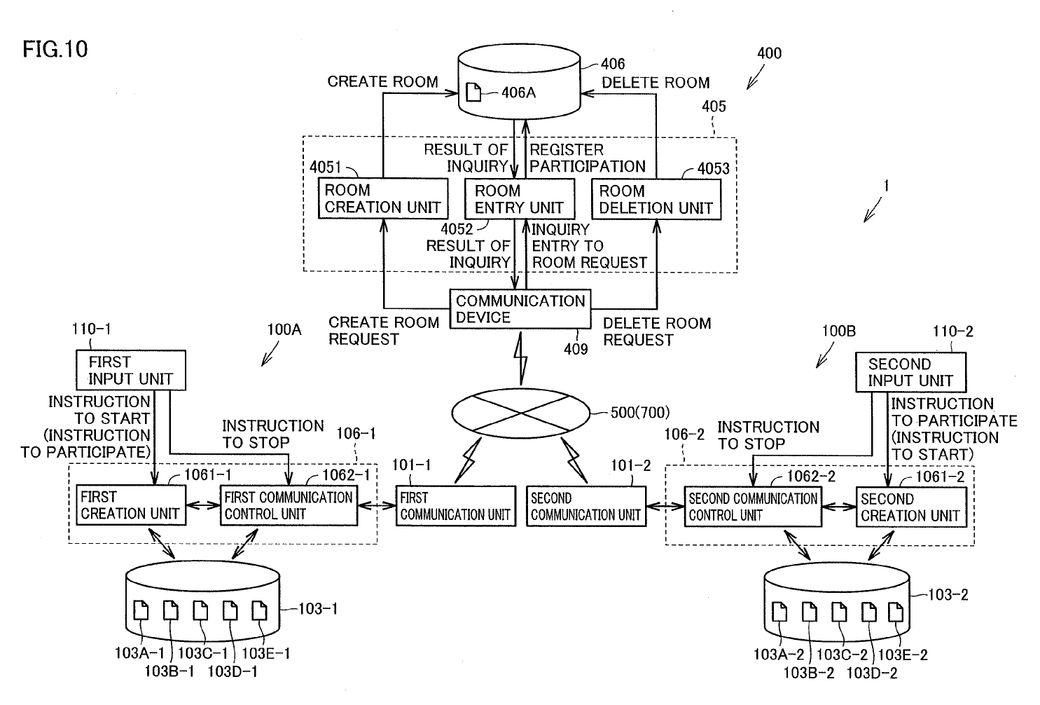

FIG. 10 is a block diagram showing a functional configuration of network system 1 according to the present embodiment. With reference to FIG. 10, network system 1 according to the present embodiment includes first mobile phone 100A, second mobile phone 100B, matching server 400, Internet 500, and carrier network 700. First mobile phone 100A includes a first communication unit 101-1, a first creation unit 1061-1, a first communication control unit 1062-1, a first memory 103-1, and a first input unit 110-1. Second mobile phone 100B includes a second communication unit 101-2, a second creation unit 1061-2, a second communication control unit 1062-2, a second memory 103-2, and a second input unit 110-2. Matching server 400 includes communication device 409, a room creation unit 4051, a room entry unit 4052, a room deletion unit 4053, and memory 406.

Function of Matching Server 400

Initially, matching server 400 has functions, as will be described hereinafter. As has been described previously, memory 406 has room management table 406A stored therein.

Communication device 409 communicates data with first mobile phone 100A, second mobile phone 100B, and the like via Internet 500, carrier network 700, and/or the like. For example, communication device 409 receives a create room request for creating a new room, a delete room request for deleting a room, a search for room request for a search to inquire whether a room exists, an entry to room request for entering a room, and the like from first mobile phone 100A, second mobile phone 100B, and/or the like.

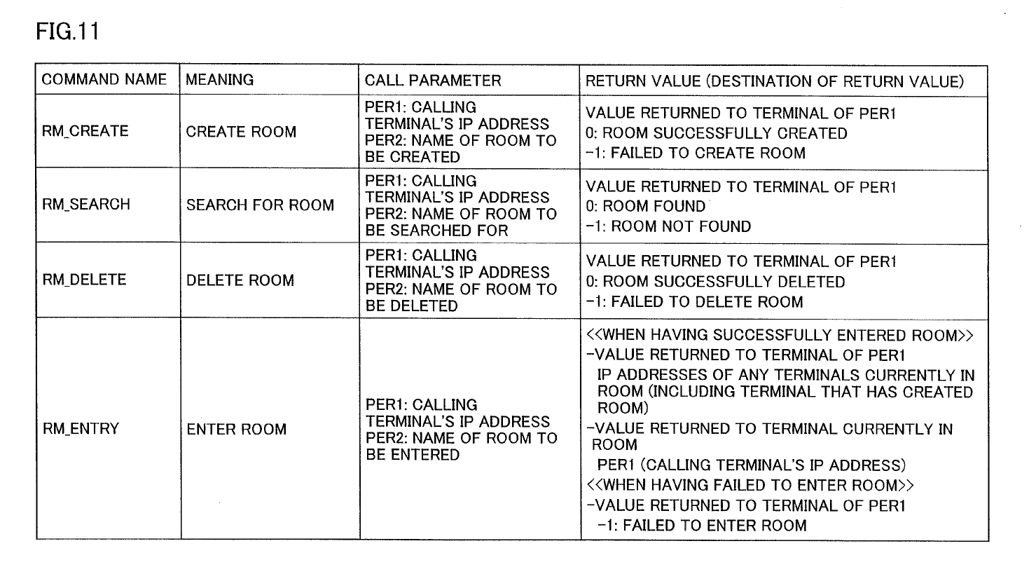

FIG. 11 represents one example of a message (or a command) communicated between matching server 400 and first mobile phone 100A and second mobile phone 100B. With reference to FIG. 11, the create room request is a message for a request to create a room, and its command name is “RM_CREATE”. First mobile phone 100A or second mobile phone 100B transmits as the create room request the IP address of first mobile phone 100A or second mobile phone 100B and a room name of a room to be created. Matching server 400 receives the request, and, as will be described hereinafter, creates a new room corresponding to the room name. Matching server 400 returns to first mobile phone 100A or second mobile phone 100B a message indicating whether the room has successfully been created.

The search for room request is a message for a request to search for a room, and its command name is “RM_SEARCH”. First mobile phone 100A or second mobile phone 100A transmits as the search for room request the IP address of first mobile phone 100A or second mobile phone 100B and a room name to be searched for. Matching server 400 receives the request, and, as will be described hereinafter, determines whether the room name is stored in room management table 406A. Matching server 400 returns to first mobile phone 100A or second mobile phone 100B a message indicating whether a room having the room name exists.

The delete room request is a message for a request to delete a room, and its command name is “RM_DELETE”. First mobile phone 100A or second mobile phone 100B transmits as the delete room request the IP address of first mobile phone 100A or second mobile phone 100B and the room name of a room to be deleted. Matching server 400 receives the request and deletes the room corresponding to the room name from room management table 406A. Matching server 400 returns to first mobile phone 100A or second mobile phone 100B a message indicating whether the room has successfully been deleted.

The entry to room request is a message for entering a room, and its command name is “RM ENTRY”. First mobile phone 100A or second mobile phone 100B transmits as the entry to room request the IP address of first mobile phone 100A or second mobile phone 100E and the room name of a room to be entered. Matching server 400 receives the request and associates the IP address of first mobile phone 100A or second mobile phone 100B with the room name and thus stores them to room management table 406A. Matching server 400 returns to first mobile phone 100A or second mobile phone 100B a message indicating whether it has successfully entered the room.

Referring again to FIG. 10, room creation unit 4051, room entry unit 4052 and room deletion unit 4053 are implemented by the matching server 400 CPU 405 executing a program stored in memory 406, fixed disk 407, and/or the like to control each hardware shown in FIG. 8. For example, each function of CPU 405 is implemented by CPU 405 once reading a program that is stored in fixed disk 407 into memory 406, and reading that program from memory 406, while sequentially executing the program.

Room creation unit 4051 for example receives a create room request from first mobile phone 100A through communication device 409. Room creation unit 4051 responds to the request by creating a new room having a room name included in the request. More specifically, room creation unit 4051 associates the room name with the IP address of first mobile phone 100A and thus stores them to room management table 406A. Room creation unit 4051 transmits a result of a determination through communication device 409 to first mobile phone 100A.

Room entry unit 4052 for example receives from second mobile phone 100B through communication device 409 an inquiry of whether a chat room having a room name is present or absent. Room entry unit 4052 determines whether the room name is stored in room management table 406A. Room entry unit 4052 transmits a result of the determination through communication device 409 to second mobile phone 100B.

Furthermore, room entry unit 4052 for example receives a request from second mobile phone 100B through communication device 409 for entering a chat room. Room entry unit 4052 responds to the request by storing the IP address of second mobile phone 100E to room management table 406A in association with a room name included in the request. When a predetermined condition for the room is satisfied, room entry unit 4052 transmits to each communication terminal currently in the room the IP address(es) of the other communication terminal(s) currently in the room.

Note that the predetermined condition corresponds for example to: that the number of IP addresses associated with a room name has reached a preset number; that a preset time has elapsed since a room was created; and the like.

Room deletion unit 4053 for example receives a request from first mobile phone 100A through communication device 409 to delete a chat room having a room name. Room deletion unit 4053 responds to the request by deleting data associated with that room name in room management table 406A, or by setting on a deletion flag corresponding to the room name in room management table 406A. Room deletion unit 4053 transmits a result of a determination through communication device 409 to first mobile phone 100A.

Function of First Mobile Phone 100A

First mobile phone 100A has functions, as will be described hereinafter. First communication unit 101-1 is implemented by data communication device 101 or audio communication device 102 of first mobile phone 100A. First memory 103-1 is implemented by memory 103 of first mobile phone 100A. First input unit 110-1 is implemented by touch panel 104, button 110 and/or the like of first mobile phone 100A. First creation unit 1061-1 and first communication control unit 1062-1 are implemented by the first mobile phone 100A CPU 106 executing a program stored in memory 103 to control each hardware shown in FIG. 6.

First memory 103-1 stores first identification information (a telephone number, a mail address, an IP address and the like) for identifying first mobile phone 100A, and second identification information (a telephone number, a mail address, an IP address and the like) for identifying second mobile phone 100B. More specifically, first memory 103-1 has address book data 103B, its terminal's data 103C, IP address data 103D of a partner of a communication, its terminal's IP address data 103E, and the like stored therein.

First creation unit 1061-1 receives a start instruction during audio communication from a user through first input unit 110-1 to start P2P communication. More specifically, the user inputs the instruction to start the P2P communication with a partner of the audio communication. First creation unit 1061-1 responds to the start instruction by creating a new room name based on its own telephone number and that of the partner of the audio communication (or second mobile phone 100B).

First communication control unit 1062-1 inquires of matching server 400 through first communication unit 101-1 whether a chat room corresponding to the room name exists.

If so, first communication control unit 1062-1 transmits a request through first communication unit 101-1 to matching server 400 for entering the room. First communication control unit 1062-1 can thus obtain the IP address of the partner's communication terminal from matching server 400 and is thus capable of performing P2P communication through first communication unit 101-1.

If a chat room corresponding to the room name does not exist, first communication control unit 1062-1 transmits a create room request together with that room name through first communication unit 101-1 to matching server 400 to create a new chat room. Thereafter, once the partner's communication terminal has entered the chat room, first communication control unit 1062-1 can obtain the IP address of the partner's communication terminal from matching server 400 and is thus capable of performing P2P communication with the partner's communication terminal through first communication unit 101-1.

Function of Second Mobile Phone 100B

Second mobile phone 100B has functions, as will be described hereinafter. Second communication unit 101-2 is implemented by data communication device 101 or audio communication device 102 of second mobile phone 100B. Second memory 103-2 is implemented by memory 103 of second mobile phone 100B. Second input unit 110-2 is implemented by touch panel 104, button 110 and/or the like of second mobile phone 100B. Second creation unit 1061-2 and second communication control unit 1062-2 are implemented by the second mobile phone 100B CPU 106 executing a program stored in memory 103 to control each hardware shown in FIG. 5.

Second memory 103-2 stores second identification information (a telephone number, a mail address, an IP address and the like) for identifying second mobile phone 100B, and first identification information (a telephone number, a mail address, an IP address and the like) for identifying first mobile phone 100A. More specifically, second memory 103-2 has address book data 103B, its terminal's data 103C, IP address data 103D of a partner of a communication, its terminal's IP address data 103E, and the like stored therein.

Second creation unit 1061-2 receives a start instruction during audio communication from a user through second input unit 110-2 to start P2P communication. More specifically, the user inputs the instruction to start the P2P communication with a partner of the audio communication. Second creation unit 1061-2 responds to the start instruction by creating a new room name based on its own telephone number and that of the partner of the audio communication (or first mobile phone 100A).

Second communication control unit 1062-2 inquires of matching server 400 through second communication unit 101-2 whether a chat room corresponding to the room name exists.

If so, second communication control unit 1062-2 transmits a request through second communication unit 101-2 to matching server 400 for entering the room. Second communication control unit 1062-2 can thus obtain the IP address of the partner's communication terminal from matching server 400 and is thus capable of performing P2P communication through second communication unit 101-2.

If a chat room corresponding to the room name does not exist, second communication control unit 1062-2 transmits a create room request together with that room name through second communication unit 101-2 to matching server 400 to create a new chat room. Thereafter, once the partner's communication terminal has entered the chat room, second communication control unit 1062-2 can obtain the IP address of the partner's communication terminal from matching server 400 and is thus capable of performing P2P communication with the partner's communication terminal through second communication unit 101-2.

Creating a Room Name

First creation unit 1061-1 and second creation unit 1061-2 operate to create a room name in a method, as will be described hereinafter. For example, first creation unit 1061-1 creates a room name constituted of a first telephone number of first mobile phone 100A and a second telephone number of second mobile phone 100B that are simply aligned. Since a telephone number is data unique to a terminal, the room name constituted of the aligned first and second telephone numbers is data unique to a group and does not overlap other groups' room names. When whether a room exists is confirmed (in FIG. 2 at step S022) it is preferable to confirm whether the room exists for a room name constituted of telephone numbers with their places replaced.

Alternatively, first creation unit 1061-1 may create a room name constituted of other identification information (a mail address, a nickname and the like) corresponding to the telephone number of first mobile phone 100A and other identification information of second mobile phone 100B that are arranged in alphabetical order.

Furthermore, first creation unit 1061-1 may use a hash function or the like to encrypt and then align the first telephone number and the second telephone number to create a room name. Network system 1 according to the present embodiment does not require restoring original data. Accordingly, the telephone numbers are encrypted preferably in a method that prevents the original data from being easily restored. For example, it is preferable to encrypt the telephone numbers by an irreversible function.

In network system 1 according to the present embodiment, second creation unit 1061-2 creates a room name by a method similar to that used for first creation unit 1061-1. Thus, second mobile phone 100B invited can create a room name for itself. That is, the user of first mobile phone 100A is not required to notify the user of second mobile phone 100B of a room name before starting P2P communication.

More specifically, the users of first mobile phone 100A and second mobile phone 100B are not required to input an instruction to select a partner for P2P communication . Furthermore, the users are not required to create a room name or input a room name. In other words, this significantly reduces an effort made by the users of first mobile phone 100A and second mobile phone 100B before starting P2P communication.

Thus the present embodiment provides network system 1 allowing each communication terminal to create a room name which does not overlap that of another chat room. This liberates the user of each communication terminal from the burden of creating a room name which does not overlap that of the other chat room. Network system 1 according to the present embodiment can also save the user's time and effort required to input a room name of a chat room.

<Communication Process in Mobile Phone 100>

In the present embodiment, mobile phone 100 provides a communication process, as will be described hereinafter. FIG. 12 is a flow chart of a procedure of the communication process performed in mobile phone 100 according to the present embodiment.

With reference to FIG. 12, CPU 106 initially causes display 107 to display a standby screen (step S102). CPU 106 determines whether address book button 110D (or a software button displayed on touch panel 104 for an address book) has been operated (step S104). If so (YES in step S104), CPU 106 performs an outgoing call process (step S200). The outgoing call process (step S200) will be described later.

If address book button 110D is not operated (NO in step S104), CPU 106 determines whether there is any telephone call alert (or any incoming call) (step S106). If so (YES in step S106), CPU 106 performs an incoming call process (step S500). The incoming call process (step S500) will be described later. Otherwise (NO in step S106), CPU 106 repeats steps S104 et seq.

<Outgoing Call Process in Mobile Phone 100>

In the present embodiment, mobile phone 100 performs the outgoing call process, as will be described hereinafter. FIG. 13 is a flow chart of a procedure of the outgoing call process in mobile phone 100 according to the present embodiment.

With reference to FIG. 13, when address book button 110D is operated (YES in step S104), CPU 106 causes display 107 to display an address book in a list based on address book data 103B (step S202). The user presses button 110 (or touches one of records of terminals of partners displayed on touch panel 104) to select the communication terminal of a partner for a TEL telephone call (step S204). In other words, CPU 106 receives an instruction via button 110 or touch panel 104 to select a communication terminal.

With the partner's communication terminal having been selected, CPU 106 determines whether TEL button 110A (or a software button displayed on touch panel 104 for starting audio communication) has been operated (step S206). If so (YES in step S206), CPU 106 performs an outgoing TEL call process (step S300). The outgoing TEL call process (300) will be described later.

If TEL button 110A is not operated (NO in step S206), CPU 106 determines whether end button 110E (or a software button displayed on touch panel 104 for ceasing audio communication) has been operated (step S208). If so (YES in step S208), CPU 106 ends the outgoing call process and repeats step S102 et seq. Otherwise (NO in step S208), CPU 106 repeats step S206 et seq.

<Outgoing TEL Call Process in Mobile Phone 100>

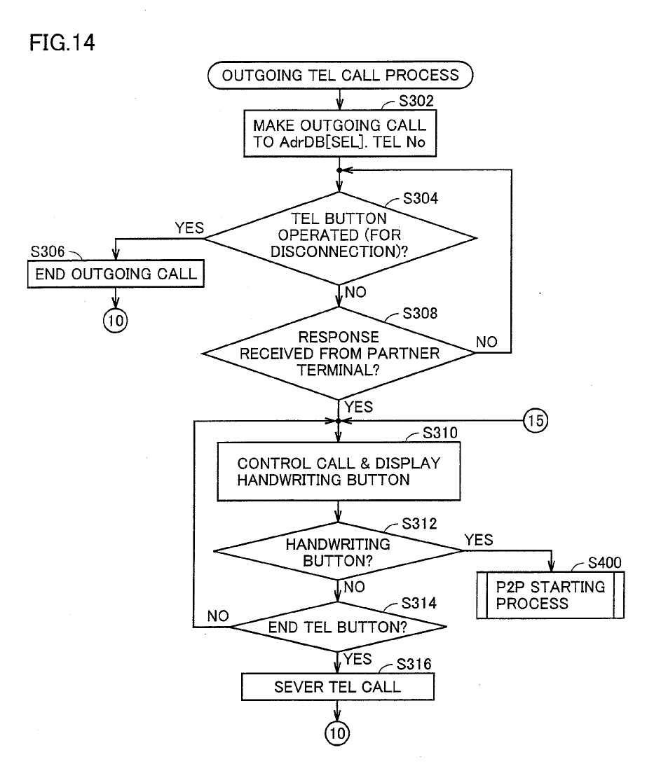

In the present embodiment, mobile phone 100 performs the outgoing TEL call process, as will be described hereinafter. FIG. 14 is a flow chart of a procedure of the outgoing TEL call process in mobile phone 100 according to the present embodiment.

With reference to FIG. 14, when TEL button 110A is operated (YES in step S206), CPU 106 makes an outgoing call through audio communication device 102 to the telephone number of a communication terminal selected (or a telephone number corresponding to a memory number stored in memory 103 at SEL) (step S302). That is, CPU 106 makes a telephone call via data communication device 101 or audio communication device 102 to the communication terminal of a partner selected from the address book.

CPU 106 determines whether TEL button 110A (or a software button displayed on touch panel 104 for ending audio communication) has been operated (step S304). If so (YES in step S304), CPU 106 interrupts the outgoing TEL call (step S306) and repeats step S102 et seq.

Otherwise (NO in step S304), CPU 106 awaits a response from the partner's communication terminal (step S308). If there is no response from the partner's communication terminal (NO in step S308), CPU 106 repeats step S304 et seq.

If there is a response from the partner's communication terminal (YES in step S308), CPU 106 exercises control for the call (step S310). Thereafter, up to step S316, as shown in FIG. 4(a), CPU 106 causes touch panel 104 to display handwriting button 104A for receiving an instruction issued to start handwritten chat communication (in the present embodiment, P2P communication). Alternatively, CPU 106 utilizes any of hardware buttons 110 as handwriting button 104A.

In the present embodiment, as shown in FIG. 4(a), CPU 106 also causes touch panel 104 to display an end TEL button 104B during controlling the call for ceasing doing so.

When handwriting button 104A is pressed (YES in step S312), CPU 106 performs a P2P starting process (step S400). The P2P starting process (step S400) will be described later.

If handwriting button 104A is not pressed (NO in step S312), CPU 106 determines whether end TEL button 104B on touch panel 104 has been pressed or whether an end TEL signal has externally been received (step S314).

If neither end TEL button 104B is operated nor the end TEL signal is received (NO in step S314), CPU 106 repeats step S310 et seq.

If end TEL button 104B is pressed or the end TEL signal is received (YES in step S314), CPU 106 severs the TEL telephone call (step S316). Subsequently, CPU 106 repeats step S102 et seq.

<P2P Communication Process in Mobile Phone 100>

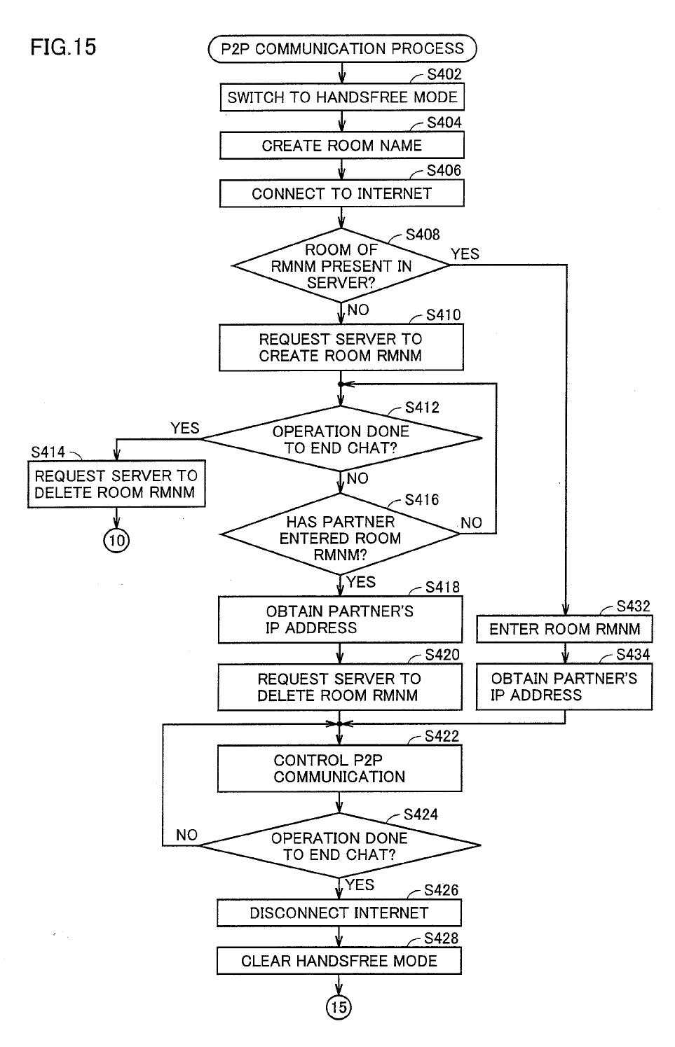

In the present embodiment, mobile phone 100 performs a P2P communication process, as will be described hereinafter. FIG. 15 is a flow chart of a procedure of the P2P communication process in mobile phone 100 in the present embodiment.

With reference to FIG. 15, if a P2P button 110C is operated (YES in step S312 or YES in step S520), CPU 106 increases an audio output from speaker 109 and increases microphone 108 in sensitivity (step S402). In other words, CPU 106 causes a communication terminal to shift to a “handsfree mode” or a “speaker phone mode”.

CPU 106 follows a predetermined rule to create a chat room name from the telephone number of the communication terminal of a partner (i.e., a value of RCVTELNO) and the telephone number of its own terminal (i.e., a value of MyAdr.TELNo) (step S404). For example, CPU 106 substitutes a return value of a HASH function, i.e., HASH (RCVTELNO, MyAdr.TELNo), in RMNM.

CPU 106 connects to Internet 500 through data communication device 101 (step S406). At the time, mobile phone 100 is assigned an IP address. CPU 106 inquires of matching server 400 through data communication device 101 whether there exists a chat room having a chat room name stored in RMNM (step S408).

It there does not exist a chat room having a chat room name stored in RMNM (NO in step S408), CPU 106 transmits a create room request via data communication device 101 to matching server 400 to create a chat room having a chat room name of RMNM (step S410).

CPU 106 determines whether the P2P button has been operated by the user via button 110 (step S412). In other words, CPU 106 determines whether an instruction has been received from the user to interrupt P2P communication. If the user has operated the P2P button (YES in step S412), CPU 106 transmits a delete room request via data communication device 101 to matching server 400 to delete a chat room having a chat room name of RMNM (step S414), and repeats step S102 et seq.

If not (NO in step S412), CPU 106 determines whether the partner's communication terminal has entered the created chat room (step S416). If not (NO in step S416), CPU 106 repeats step S412 et seq.

If the partner's communication terminal has entered the created chat room (YES in step S416), CPU 106 stores the received IP address of the partner's communication terminal to HIS_IPADR (step S418). CPU 106 transmits a delete room request via data communication device 101 to matching server 400 to delete a chat room having a chat room name of RMNM (step S420), and, as shown in FIG. 4(d), starts controlling P2P data communication (step S422).

If there exists in matching server 400 a chat room having a chat room name stored in RMNM (YES in step S408), CPU 106 enters the chat room of matching server 400 via data communication device 101 (step S432). In other words, CPU 106 transmits an entry to room request to matching server 400 via data communication device 101.

CPU 106 obtains the IP address of the partner for the P2P communication from matching server 400 via data communication device 101 (step S434). CPU 106 stores the partner's IP address to HIS_IPADR and, as shown in FIG. 4(d), starts controlling the P2P communication (step S422).

CPU 106 determines via button 110 or an end chat button 104C whether the user has operated end P2P button 104C (see FIG. 4) or whether notification has been received from the communication terminal of the partner of the P2P communication to end the communication (step S424). In other words, CPU 106 determines whether an instruction has been received from the user to interrupt the P2P communication. If the P2P button is not operated (NO in step S424), CPU 106 repeats step S422 et seq.

If the P2P button is operated (YES in step S424), CPU 106 disconnects from Internet 500 (step S426). CPU 106 clears the handsfree mode or the speaker phone mode (step S428). Subsequently, CPU 106 repeats step S310 et seq.

<Incoming Call Process in Mobile Phone 100>

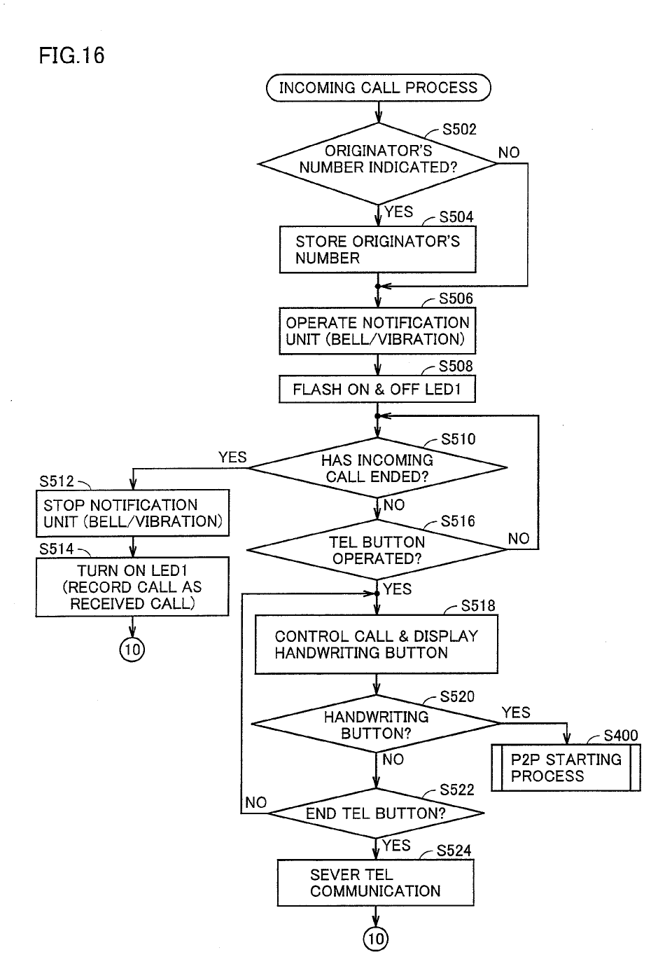

In the present embodiment, mobile phone 100 performs the incoming call process, as will be described hereinafter. FIG. 16 is a flow chart of a procedure of the incoming call process in mobile phone 100 according to the present embodiment.

With reference to FIG. 16, if there is any telephone call alert (YES in step S 106), CPU 106 determines whether the originator's telephone number is indicated (step S502). If not (NO in step S502), CPU 106 performs step S506 et seq.

If the originator's telephone number is indicated (YES in step S502), CPU 106 stores the originator's telephone number to RCVTELNO (step S504). CPU 106 operates first notification unit 111, i.e., outputs a ringer tone through speaker 109 or the like or vibrates mobile phone 100 by a vibration function (step S506). CPU 106 operates second notification unit 112, i.e., flashes on/off LED 112A for TEL (step S508).

CPU 106 determines whether the incoming call has ended (step S510). If so (YES in step S510), CPU 106 stops first notification unit 111, i.e., stops the ringer tone output via speaker 109 or the like or stops mobile phone 100 from the vibration via the vibration function (step S512). CPU 106 operates second notification unit 112, i.e., turns on LED 112A for TEL (step S514) and registers the originator's number of the partner's communication terminal, the arrival time thereof, and the like in memory 103 as an arrival history, and repeats step S102 et seq.

If the incoming call has not ended (NO in step S510), CPU 106 determines whether TEL button 110A has been operated (step S516). If not (NO in step S516), CPU 106 repeats step S510 et seq.

If TEL button 110A is operated (YES in step S516), CPU 106 controls the telephone call (step S518). Thereafter, up to step S522, as shown in FIG. 4(a), CPU 106 causes touch panel 104 to display handwriting button 104A for receiving an instruction issued to start handwritten chat communication (in the present embodiment, P2P communication). Alternatively, CPU 106 uses any of hardware buttons 110 as handwriting button 104A.

In the present embodiment, as shown in FIG. 4(a), CPU 106 also causes touch panel 104 to display end TEL button 104B during controlling the call for ceasing doing so.

When handwriting button 104A is pressed (YES in step S520), CPU 106 performs the above described P2P starting process (step S400).

If handwriting button 104A is not pressed (NO in step S520), CPU 106 determines whether end TEL button 104B on touch panel 104 has been pressed or whether an end TEL signal has externally been received (step S522).

If neither end TEL button 104B is operated nor the end TEL signal is received (NO in step S522), CPU 106 repeats step S518 et seq.

If end TEL button 104B is pressed or the end TEL signal is received (YES in step S522), CPU 106 severs the TEL telephone call (step S524). CPU 106 repeats step S102 et seq.

<Response Process in Matching Server 400>

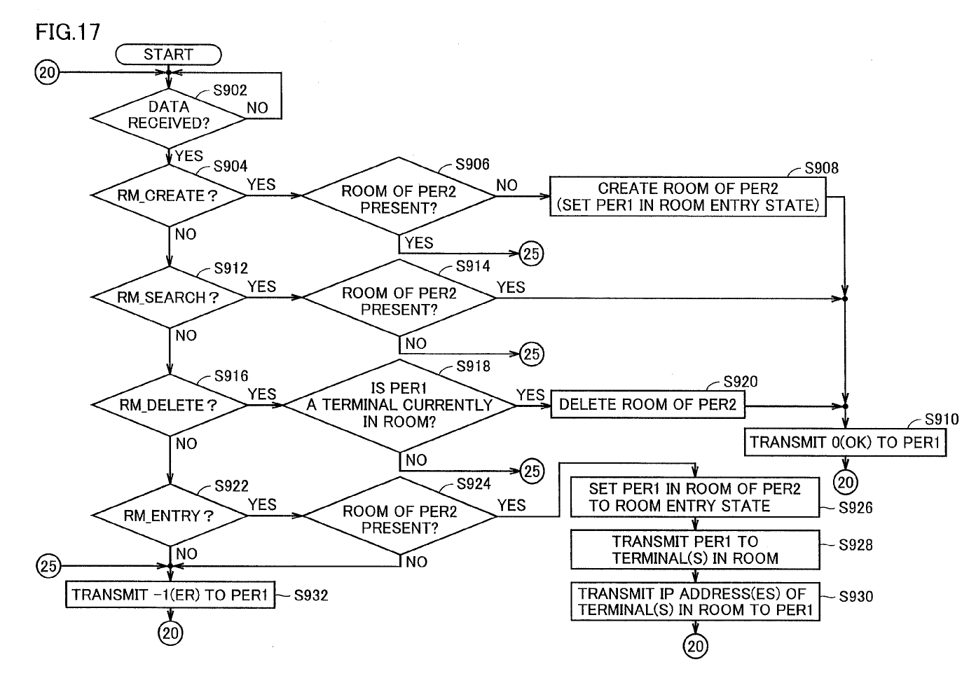

In the present embodiment, matching server 400 provides a response process, as will be described hereinafter. FIG. 17 is a flow chart of a procedure of the response process in matching server 400 according to the present embodiment.

With reference to FIG. 17, the matching server 400 CPU 405 waits for a message received from first mobile phone 100A through communication device 409 (step S902). When CPU 405 receives a message from first mobile phone 100A (YES in step S902), CPU 405 determines whether the message is a create room request to create a chat room (step S904).

If so (YES in step S904), CPU 406 determines whether the create room request includes a room name present in room management table 406A (step S906). If so (YES in step S906), CPU 406 issues notification that creating the room has failed (step S932), and the CPU repeats step S902 et seq.

If the room name does not exist in room management table 406A (NO in step S906), CPU 406 creates a room having the room name (step S908). More specifically, CPU 406 stores the room name and the IP address of the caller included in the create room request to room management table 406A in association with each other. CPU 406 issues to the caller's IP address a notification indicating that the room has successfully been created (step S910), and the CPU repeats step S902 et seq.

If the message is not a create room request to create a chat room (NO in step S904), CPU 406 determines whether the message is a search for room request to search for a room name (step S912).

If the message is a search for room request to search for a chat room (YES in step S912), the CPU determines whether the search for room request includes a room name present in room management table 406A (step S914). If so (YES in step S914), CPU 406 issues to the requester's IP address a notification indicating that the room has been found (step S910), and the CPU repeats step S902 et seq.

If the room name does not exist in room management table 406A (NO in step S914), CPU 406 issues to the requester's IP address a notification indicating that the room name has not been found (step S932), and the CPU repeats step S902 et seq.

If the message is not a search for room request to search for a chat room (NO in step S912), CPU 406 determines whether the message is a delete room request to delete a chat room (step S916).

If the message is a delete room request to delete a chat room (YES in step S916), CPU 406 determines whether the requester's IP address is stored in room management table 406A in association with a room name included in the delete room request (step S918). More specifically, CPU 406 determines whether the requester's communication terminal is a communication terminal having entered the chat room.

If the requester's IP address is stored in room management table 406A in association with a room name included in the delete room request (YES in step S918), CPU 406 deletes the chat room having the room name (step S920). CPU 406 issues to the requester's IP address a notification indicating that the chat room has successfully been deleted (step S910), and the CPU repeats step S902 et seq.

If the requester's IP address is not stored in room management table 406A in association with the room name included in the delete room request (NO in step S918), CPU 406 issues to the requester's IP address a notification indicating that deleting the chat room has failed (step S932), and the CPU repeats step S902 et seq.

If the message is not a delete room request to delete a chat room (NO in step S916), CPU 406 determines whether the message is an entry to room request for entering a chat room (step S922).

If so (YES in step S922), CPU 406 determines whether the entry to room request includes a room name stored in room management table 406A (step S924). If so (YES in step S924), CPU 406 registers the requester's IP address in room management table 406A in association with the room name (step S926).

CPU 406 transmits the requester's IP address through communication device 409 to the IP address(es) having been registered in room management table 406A in association with the room name (step S928). CPU 406 transmits to the requester's IP address through communication device 409 the IP address(es) having been registered in room management table 406A in association with the room name (step S930). Subsequently, CPU 406 repeats step S902 et seq.

If the message is not an entry to room request for entering a chat room (NO in step S922), and if the entry to room request does not include a room name stored in room management table 406A (NO in step S924), CPU 406 transmits an error message to the requester's IP address (step S932), and the CPU repeats step S902 et seq.

<Other Application of Network System 1 According to the Present Embodiment>

It is needless to say that the present invention is also applicable to a case achieved by providing a system or a device with a program. The present invention's effect can also be exploited in such a manner that a storage medium having stored therein a program represented by software for achieving the present invention is provided to a system or a device and a computer (or CPU or MPU) of the system or device reads and executes a program code stored in the storage medium.

In that case, the program code per se read from the storage medium will implement the function of the above described embodiment, and the storage medium having the program code stored therein will configure the present invention.

The storage medium for providing the program code can for example be a hard disc, an optical disc, a magneto-optical disc, a CD-ROM, a CD-R, a magnetic tape, a non-volatile memory card (an IC memory card), ROMs (mask ROM, flash EEPROM, or the like), or the like.

Furthermore, it is needless to say that not only can the program code read by the computer be executed to implement the function of the above described embodiment, but a case is also included in which in accordance with the program code's instruction an operating system (OS) running on the computer performs an actual process partially or entirely and that process implements the function of the above described embodiment.

Furthermore, it is also needless to say that a case is also included in which the program code read from the storage medium is written to memory included in a feature expansion board inserted in a computer or a feature expansion unit connected to the computer, and subsequently, in accordance with the program code's instruction, a CPU or the like included in the feature expansion board or the feature expansion unit performs an actual process partially or entirely and that process implements the function of the above described embodiment.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### REFERENCE SIGNS LIST

1: network system; 100, 100A, 100B, 100C: mobile phone; 101: first communication device; 102: second communication device; 103, 103-1,103-2: memory; 103A, 103A-1, 103A-2: work memory; 103B, 103B-1, 103B-2: address book data; 103C, 103C-1, 103C-2: own terminal's data; 103D, 103D-1, 103D-2: IP address data of partner of communication; 103E, 103E-1, 103E-2: own terminal's IP address data; 106, 106-1, 106-2: CPU; 1061, 1061-1, 1061-2: creation unit; 1062, 1062-1, 1062-2: communication control unit; 107: display; 108: microphone; 109: speaker; 110, 110-1, 110-2: input unit; 200: car navigation device; 300: personal computer; 400: matching server; 405A: room creation unit; 405B: room entry unit; 405C: room deletion unit; 406: memory; 406A: room management table; 407: fixed disk; 408: internal bus; 409: communication device; 500: Internet; 700: carrier network.

1. A communication terminal for communicating with another communication terminal, comprising:
a first communication device;
a second communication device;
a speaker;
a microphone; and
a processor, said processor performing audio communication with said other communication terminal via said first communication device, said speaker and said microphone, receiving during said audio communication with said other communication terminal an instruction issued to start data communication, and, while performing said audio communication, also performing said data communication in response to said instruction with said other communication terminal via said second communication device.

2. The communication terminal according to claim 1, further comprising a touch panel, wherein:
during said data communication with said other communication terminal, said processor receives a first handwritten image input via said touch panel and transmits said first handwritten image via said second communication device to said other communication terminal; and
during said data communication with said other communication terminal, said processor receives a second handwritten image from said other communication terminal via said second communication device and causes said touch panel to display said second handwritten image.

3. The communication terminal according to claim 2, wherein during said audio communication with said other communication terminal, said processor causes said touch panel to display a software button operated to receive an instruction issued to start said data communication.

4. The communication terminal according to claim 1, further comprising a hardware button, wherein during said audio communication with said other communication terminal, said processor receives via said hardware button an instruction issued to start said data communication.

5. The communication terminal according to claim 1, wherein said processor shifts the communication terminal to a handsfree mode when the communication terminal starts said data communication.

6. A communication method performed in a communication terminal including first and second communication devices, a speaker, a microphone, and a processor, comprising the steps of:
performing, by said processor, audio communication with another communication terminal via said first communication device, said speaker and said microphone;
during said audio communication with said other communication terminal, receiving, by said processor, an instruction issued to start data communication; and
while performing said audio communication, performing, by said processor, said data communication in response to said instruction with said other communication terminal via said second communication device.

7. A computer readable storage medium having a communication program stored therein for causing a communication terminal to perform communication, said communication terminal including first and second communication devices, a speaker, a microphone, and a processor, said communication program causing said processor to perform the steps of:
performing audio communication with another communication terminal via said first communication device, said speaker and said microphone;
during said audio communication with said other communication terminal, receiving an instruction issued to start data communication; and
while performing said audio communication, also performing said data communication in response to said instruction with said other communication terminal via said second communication device.
